(19) United States
(12) Patent Application Publication
(10) Pub. No.: US 2008/0300832 A1
(43) Pub. Date: Dec. 4, 2008

(54) INFORMATION PROCESSING APPARATUS, SIMULATION METHOD, AND PROGRAM THEREOF RECORDED ON COMPUTER-READABLE STORAGE MEDIUM

(75) Inventor: Akira UEDA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/180,232

(22) Filed: Jul. 25, 2008

Related U.S. Application Data
(63) Continuation of application No. PCT/JP2006/301211, filed on Jan. 26, 2006.

(51) Int. Cl. G06F 17/50

(52) U.S. Cl. 703/1

(57) ABSTRACT

A design/analysis linkage system performs the processing of recording, in a conversion information file, a conversion process in which design data is converted into a design information file suitable to making a model; of linking the aforementioned design information file with an analysis information file generated from the design information file for building up an analysis model; and of automatically reflecting in the design information file changes that have been made to the analysis information file during the analysis process.

### CROSS REFERENCE TO THE RELATED APPLICATION

This application is a continuation of PCT application PCT/JP2006/301211, which was filed on Jan. 26, 2006, the entire contents of which are incorporated herein by reference.

### BACKGROUND OF THE INVENTION

1. Field of the Invention

The present invention relates to an information processing apparatus, a simulation method and an information processing program stored in a computer-readable storage medium, and may be applied to a technique effectively applicable to a design aid technique based on a computer simulation, and the like technique.

2. Description of the Related Art

Recent years have witnessed the popularization of product designs by means of computer aided design (CAD). It is further known that an analysis model is built from design information data obtained through a CAD and that validation of the configuration and operation of the product is made by way of various simulations.

Incidentally, conversions from design information data have conventionally resulted in analysis models managed independently of the design information data and therefore information such as the most optimal layout and specification of components (such as fans and heat sinks) obtained by carrying out analyses has been individually reported to design engineers in order to reflect this information in the relevant design drawings. Further, when a design and/or a specification are changed, it has been unclear where the change is made.

As such, there has conventionally been the technical problem that reflection in a design process cannot be smoothly accomplished even when the most optimal geometries and/or layout are created by utilizing the analysis result of a simulation because the design information data and analysis model exist independently.

That is, it is conceivable to implement a conversion from design information data to an analysis model and/or a conversion from the analysis model to the design information data by using an intermediary file as a reference method for the conventional technique; these conversions, however, are mutually independent, breaking down the family tree relationship (i.e., hierarchical structure) of component information and that of assembly information or losing the correlation between pre- and post-conversions.

Incidentally, reference patent document 1 has disclosed a technique for generating a model from the design data of a power source/GND (grounding) layer and carrying out a surface analytic simulation in an electro-magnetic interference (EMI) design/evaluation process. That is, a frequency characteristic S parameter is measured by manufacturing a substrate having only the power source/GND layer and, when the surface analytic simulation result matches the measurement result of the S parameter measured from the substrate, a bypass capacitor is mounted on the substrate and information resulted from the mounting is fed back to the mounting detailed designing process.

The technique according to patent document 1, however, did not disclose how the information, such as the position of a component changed in accordance with the result of the simulation using the analysis model, would be reflected in the CAD data or the like.

Further, reference patent document 2 has disclosed a technique for extracting information required for preparing (or changing) CAD data from the result of a structure analysis and converting the information into the aforementioned CAD data. The technique, however, does not disclose a concept of managing design information data and an analysis model generated from the aforementioned design information data, while associating them with each other.

Meanwhile, reference patent document 3 has disclosed a technique for comparing computer aided engineering (CAE) form data, which is created on the basis of a CAE analysis result, between the pre- and post-change and reflecting the difference in CAD data. However, the technique does not disclose a concept of managing the CAE form data and CAD data, while associating them with each other.

Patent document 1: Laid-Open Japanese Patent Application Publication No. H11-66125 (laid open on Mar. 9, 1999)

Patent document 2: Laid-Open Japanese Patent Application Publication No. 2000-268076 (laid open on Sep. 29, 2000)

Patent document 3: Laid-Open Japanese Patent Application Publication No. 2001-147950 (laid open on May 29, 2001)

### SUMMARY OF THE INVENTION

An information processing apparatus according to a first aspect includes: an analysis model conversion unit generating an analysis model data from design information data; an analysis result obtainment unit obtaining an analysis result in accordance with a physical simulation on the analysis model data after the analysis model data is generated by the analysis model conversion unit; an analysis result judgment unit changing the analysis model data to re-perform the physical simulation by using the analysis result obtainment unit if the analysis result does not satisfy an analysis condition; a layout check unit reflecting a change result of the analysis model data in the design information data to check a layout indicated by the design information data if the analysis result turns out to satisfy the analysis condition by the analysis result judgment unit; and a layout check result judgment unit changing the analysis model data to re-perform the physical simulation by using the analysis result obtainment unit if a result of checking the layout indicates that the layout is improper.

An information processing apparatus according to a second aspect includes: an analysis model conversion unit generating an analysis model data from design information data; and a linkage unit storing, in the design information data and the analysis model data, information that enables cross-reference among information changed in the analysis model data, the design information data, and the analysis model data, associating the analysis model data with the design information data, and reflecting an analysis result obtained by using the analysis model data in the design information data.

The information processing apparatus according to the second aspect can be modified in a third aspect so that the analysis result includes positional information, geometry information, and layout information of a component defined by the design information data.

The information processing apparatus according to the second aspect can be modified in a fourth aspect so as to further include a storage unit storing a category of conversion processing used by the analysis model conversion unit when converting the design information data related to an individual component into the analysis model data.

The information processing apparatus according to the second aspect can be modified in a fifth aspect so as to further include an inspection unit inspecting whether or not layout information, within the analysis model data, of an individual component obtained by the analysis result is within an allowable range of design.

A simulation method according to a sixth aspect causes a computer to function as the information processing apparatus according to the first aspect.

A simulation method according to a seventh aspect makes a computer execute steps of: generating an analysis model data from design information data; storing, in the design information data and the analysis model data, information that enables cross-reference among information changed in the analysis model data, the design information data, and the analysis model data; associating the analysis model data with the design information data; performing a simulation by using the analysis model data; and reflecting an analysis result obtained from the simulation using the analysis model data into the design information data.

The simulation method according to the seventh aspect can be modified in an eighth aspect so that the analysis result includes positional information, geometry information, and layout information of a component defined by the design information data.

A computer-readable storage medium recording a simulation program according to a ninth aspect causes a computer to function as the information processing apparatus according to the first aspect.

A computer-readable storage medium recording an information processing program according to a tenth aspect makes a computer execute the steps described with respect to the seventh aspect.

### BRIEF DESCRIPTION OF THE DRAWINGS

FIG. 1 is a conceptual diagram exemplifying the configuration and operation of an information processing apparatus, a simulation method, and an information processing program according to an embodiment;

FIG. 2 is a block diagram exemplifying the configuration of an information processing apparatus according to an embodiment;

FIG. 3 is a conceptual diagram exemplifying the structure of a design information file for use in a simulation method according to an embodiment;

FIG. 4 is a conceptual diagram exemplifying the structure of a conversion information file for use in a simulation method according to an embodiment;

FIG. 5 is a conceptual diagram exemplifying simplification categories in a conversion information file for use in a simulation method according to an embodiment;

FIG. 6 is a conceptual diagram exemplifying the structure of an analysis information file for use in a simulation method according to an embodiment;

FIG. 7 is a flow chart exemplifying the operation of an information processing apparatus, a simulation method, and an information processing program according to an embodiment;

FIG. 8 is a flow chart exemplifying the operation of an information processing apparatus, a simulation method, and an information processing program according to an embodiment;

FIG. 9 is a flow chart exemplifying the operation of an information processing apparatus, a simulation method, and an information processing program according to an embodiment; and

FIG. 10 is a conceptual diagram exemplifying the analysis model of a product to which a simulation method according to an embodiment is applied.

### DESCRIPTION OF THE EMBODIMENTS

The following is a description in detail of the embodiment by referring to the accompanying drawings.

A purpose of the following embodiment is to provide a technique for enabling the shortening of a time required to feed back information to a design process from an analysis process.

An other purpose of the following embodiment is to provide a technique for enabling the shortening of a time required for a production process by quickly reflecting information obtained by an analysis process in the production process.

Yet another purpose of the following embodiment is to provide a technique for enabling an improvement in reliability of design information data by reducing mistakes which could occur when information is fed back to a design process from an analysis process.

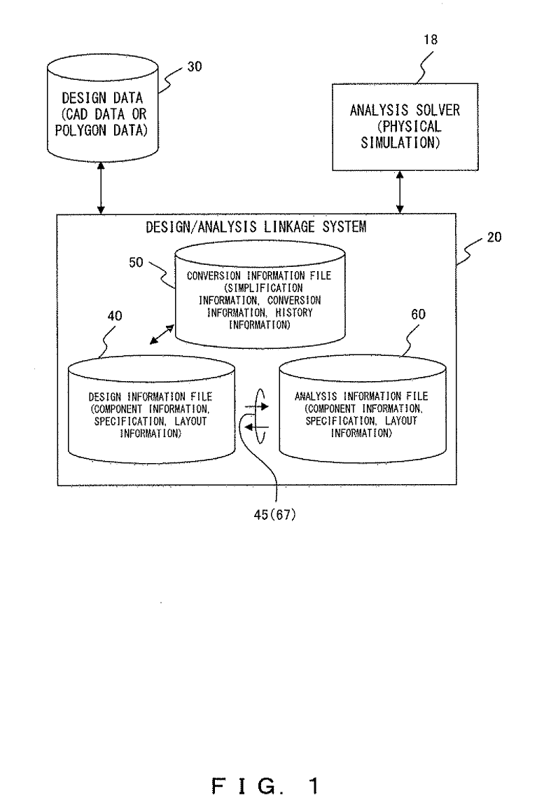

FIG. 1 is a conceptual diagram exemplifying the configuration and operation of an information processing apparatus, a simulation method, and an information processing program according to an embodiment.

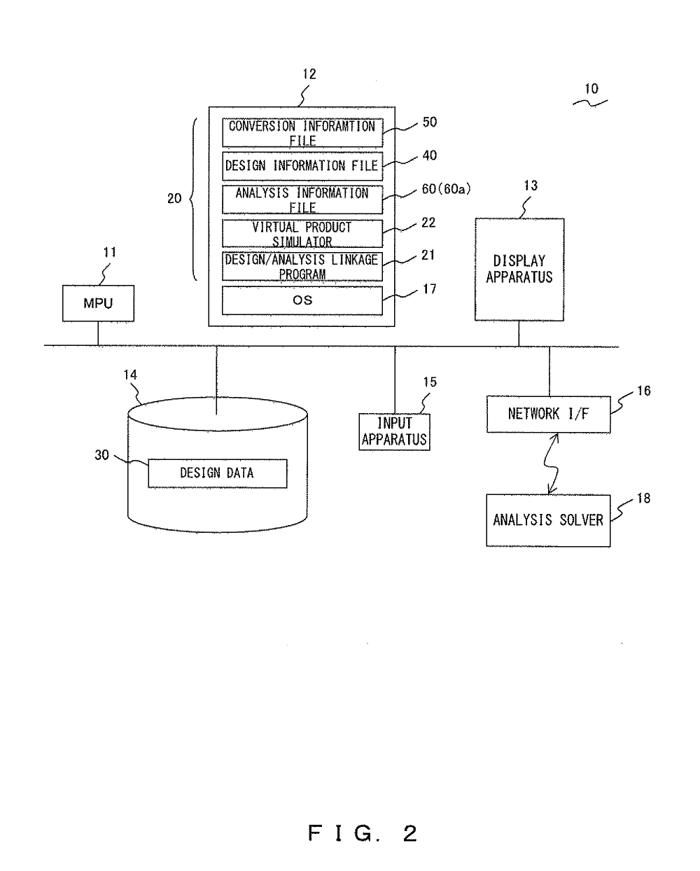

FIG. 2 is a block diagram exemplifying the configuration of an information processing apparatus according to the present embodiment.

As exemplified in FIG. 1, the present embodiment is configured such that a design/analysis linkage system 20 generates a design information file 40 by processing externally inputted design data 30 and generates an analysis information file 60 for building up an analysis model 60M from the design information file 40.

Further, information such as the progress of a conversion process from the design information file 40 to the analysis information file 60 is stored in a conversion information file 50.

The analysis model 60M built up as such is input into an externally provided analysis solver 18 for carrying out a physical simulation thereby.

If a design change is necessary in accordance with the result of the physical simulation, a change is applied to the analysis information file 60, an analysis model 60M is re-created, and a physical simulation is carried out again. These processes are repeated until a good physical simulation result is obtained.

The present embodiment is configured to reflect a change and/or addition, which are applied to the analysis information file 60, automatically in the design information file 40 in a manner described later.

Furthermore, a change reflected in the design information file 40 can be reflected in the design data 30 as appropriate by means of an inverse conversion using the conversion information file 50.

As exemplified in FIG. 2, the information processing apparatus 10 according to the present embodiment is a computer including a central processing unit 11, a main storage 12, a display apparatus 13, an external storage apparatus 14, an input apparatus 15, a network interface (I/F) 16, and an operating system (OS) 17.

The central processing unit 11 can be, for example, a micro-processing unit (MPU). The central processing unit 11 executes both the operating system 17 stored in the main storage 12 and an application program (which is also stored in the main storage 12 and is described later), thereby controlling the entirety of the information processing apparatus 10.

The main storage 12 stores both the software executed by the central processing unit 11 and data. The present embodiment is configured to implement the operating system 17 and the design/analysis linkage system 20 as an application program operated on the aforementioned operating system 17.

The display apparatus 13 displays contents such as information indicating the execution process and/or execution result of the design/analysis linkage system 20.

The external storage apparatus 14 stores the design data 30. The external storage apparatus 14 also stores the design information file 40, conversion information file 50, and analysis information file 60 on an as-required basis.

The input apparatus 15, being constituted by one or more input devices including a keyboard, mouse and the like, is used when a user inputs information into the information processing apparatus 10.

The network interface 16 transmits and receives information between the design/analysis linkage system 20 and an externally provided analysis solver 18.

The design/analysis linkage system 20 according to the present embodiment contains software including a design/analysis linkage program 21 and a virtual product simulator 22, and the above-described information, including the design information file 40, conversion information file 50, and analysis information file 60.

In accordance with the design/analysis linkage program 21, the central processing unit 11 realizes the design/analysis linkage system 20 by executing a process such as an analysis process 200 and a design data/analysis model conversion process 300, which are described later.

That is, the design/analysis linkage program 21 makes the central processing unit 11 perform the processing of generating a design information file 40 from the design data 30 and further generating an analysis information file 60 (i.e., an analysis model 60M) from the generated design information file 40. In these generation processes, the central processing unit 11 executing the design/analysis linkage program 21 equips both the design information file 40 and analysis information file 60 with linkage information parts (which are described later), thereby linking the information automatically in both files.

The virtual product simulator 22 is provided for executing a layout check process 400 which is described later.

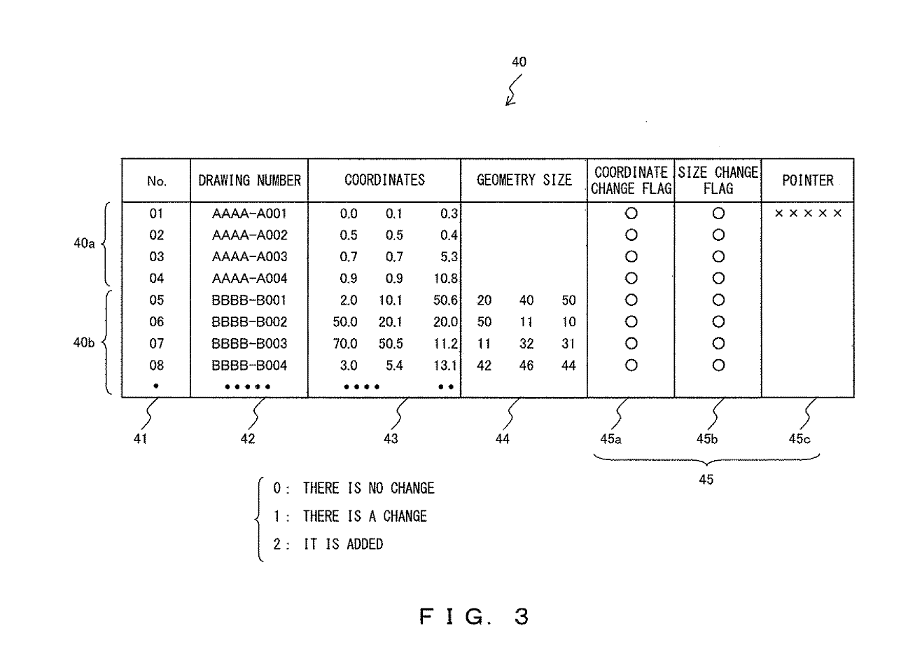

FIG. 3 is a conceptual diagram exemplifying the structure of the design information file 40 according to the present embodiment.

The design information file 40 according to the present embodiment is constituted by plural pieces of data representing design information, where each of the plural pieces includes some data items. In the present embodiment, the data items are a serial number 41, a drawing number 42, coordinates 43 (i.e., a 3-tuple of coordinates), a geometry size 44, and a linkage information part 45. Hereinafter, a piece of data representing design information is also referred to as “design information data”.

The plural pieces of design information data constituting the design information file 40 are grouped into component data 40b in which information related to a component is set and layout data 40a in which the layout information of the component is set.

The drawing number 42, coordinates 43, and geometry size 44 are pieces of information inherited from the design data 30, and the linkage information part 45 is information generated and added by the design/analysis linkage program 21.

A change process, however, is applied to the drawing number 42, coordinates 43, and geometry size 44 in accordance with the design/analysis linkage program 21, on an as-required basis, in the process of conversion processing to the analysis information file 60. Information related to the applied change process is recorded in the conversion information file 50.

The linkage information part 45 includes a coordinate change flag 45a, a size change flag 45b, and an analysis model linkage pointer 45c.

The coordinate change flag 45a is information indicating whether or not at least one coordinate in a tuple of the coordinates 43 of the present piece of design information data has been changed at the corresponding analysis information file 60. If there has been a change, “1” is set; if there is no change, “0” is set; and if the present piece of design information data is an added one, “2” is set.

Similarly, the size change flag 45b is information indicating whether or not the geometry size 44 of the present piece of design information data has been changed at the corresponding analysis information file 60. If there has been a change, “1” is set; if there is no change, “0” is set; and if the present piece of design information data is an added one, “2” is set.

The analysis model linkage pointer 45c is information indicating the corresponding piece of analysis information data at the analysis information file 60. The analysis model linkage pointer 45c makes it possible to refer directly to the corresponding piece of analysis information data within the analysis information file 60 from the design information file 40.

Meanwhile, when “2” is set, meaning that the present piece of design information data is an added one, the analysis information data added at the analysis information file 60 can be imported at the design information file 40 as design information data.

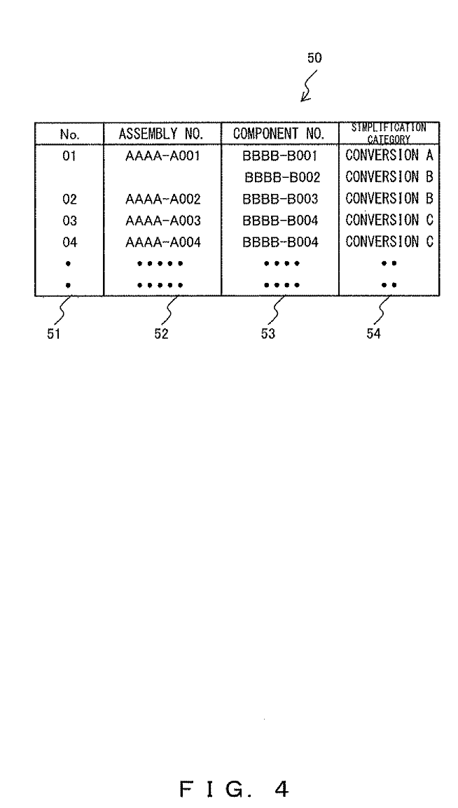

FIG. 4 is a conceptual diagram exemplifying the structure of the conversion information file 50 according to the present embodiment.

The conversion information file 50 according to the present embodiment is constituted by plural pieces of data representing conversion information, where each of the plural pieces includes some data items. In the present embodiment, the data items are a serial number 51, an assembly number 52, a component number 53, and a simplification category 54. Hereinafter, a piece of data representing conversion information is also referred to as “conversion information data”.

The simplification category 54 of individual conversion information data records the category of a conversion process for a specific component, which is identified by the combination of the assembly number 52 and component number 53.

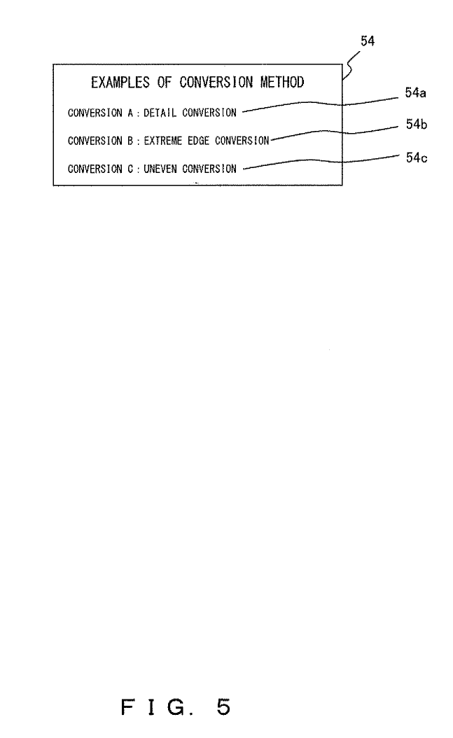

FIG. 5 is a conceptual diagram exemplifying a simplification category 54 according to a present embodiment.

In the case of the present embodiment, for example, the conversion A of the simplification category 54 indicates a detail conversion 54a. The contour geometry (i.e., outer boundary) of a component set up in the design data 30 is truly converted into a design information file 40 in the detail conversion 54a.

The conversion B of the simplification category 54 indicates an extreme edge conversion 54b. The contour geometry of a component set up in the design data 30 is converted into a design information file 40 with relatively small irregularities (i.e., concaves/convexes), screw holes and the like of the contour geometry being omitted in the extreme edge conversion 54b.

The conversion C of the simplification category 54 indicates an uneven conversion 54c. A conversion process approximating the contour geometry of a component set up in the design data 30 to a similar geometry is carried out in the uneven conversion 54c.

Note that a use of the information recorded in the conversion information file 50 also makes it possible to reconstruct the design data 30 from a design information file 40.

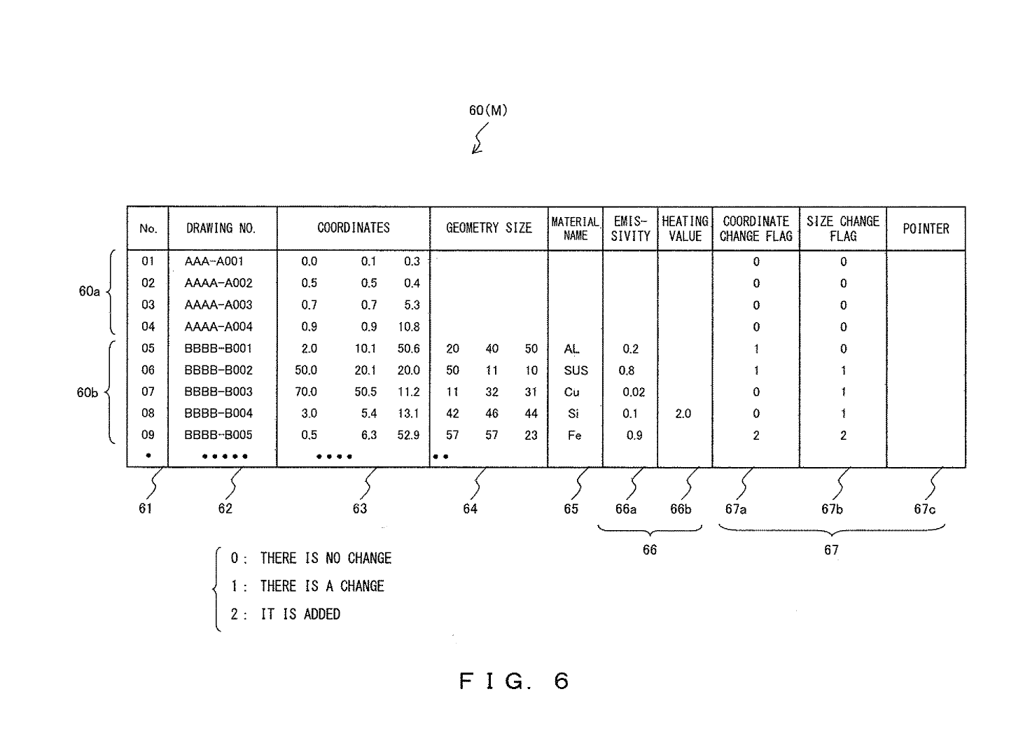

FIG. 6 is a conceptual diagram exemplifying the structure of the analysis information file 60 according to the present embodiment. The analysis information file 60 is used for structuring an analysis model 60M.

The analysis information file 60 according to the present embodiment is constituted by plural pieces of data representing analysis information, where each of the plural pieces includes some data items. In the present embodiment, the data items are a serial number 61, a drawing number 62, coordinates 63, a geometry size 64, a material name 65, a material property 66, and a linkage information part 67. Hereinafter, a piece of data representing analysis information is also referred to as “analysis information data”.

The plural pieces of analysis information data constituting the analysis information file 60 are grouped into component data 60b in which information related to a component is set and layout data 60a in which the layout information of the component is set.

The drawing number 62, coordinates 63 (i.e., 3-tuple of coordinates), and geometry size 64 are inherited from the drawing number 42, coordinates 43, and geometry size 44, respectively, of the design information file 40.

The material name 65 is information inherited from the design data 30, indicating the name of a material constituting the corresponding component.

The material property 66 is also information inherited from the design data 30. The present embodiment is configured so that the material property 66 includes emissivity 66a and a heating value 66b.

That is, the emissivity 66a indicates the value of the thermal emissivity of the corresponding component. Further, the heating value 66b is the value of a heating value when the corresponding component operates.

The linkage information part 67 is information set up the design/analysis linkage program 21 when an analysis information file 60 is generated from the design information file 40.

The linkage information part 67 includes a coordinate change flag 67a, a size change flag 67b, and a design information linkage pointer 67c.

The coordinate change flag 67a is a flag indicating whether or not a change has been applied to at least one coordinate in a tuple of the coordinates 63 of the present piece of analysis information data in the progression of the simulation process after a conversion from the design information file 40. If there has been a change, “1” is set; if there is no change, “0” is set; and if the present piece of analysis information data is an added one, “2” is set.

Likewise, the size change flag 67b is set to “1” if there has been a change; set to “0” if there is no change; and set to “2” if the present piece of analysis information data is an added one.

The design information linkage pointer 67c is the pointer information connecting the present piece of analysis information data to the corresponding piece of design information data at the design information file 40. The design information linkage pointer 67c is set up by the design/analysis linkage program 21 when converting from the design information file 40 to an analysis information file 60.

Meanwhile, the design/analysis linkage system 20, in accordance with the design/analysis linkage program 21, updates the coordinate change flag 45a and/or size change flag 45b of the corresponding piece of design information data at the design information file 40 if a change occurs in the coordinate change flag 67a and/or size change flag 67b.

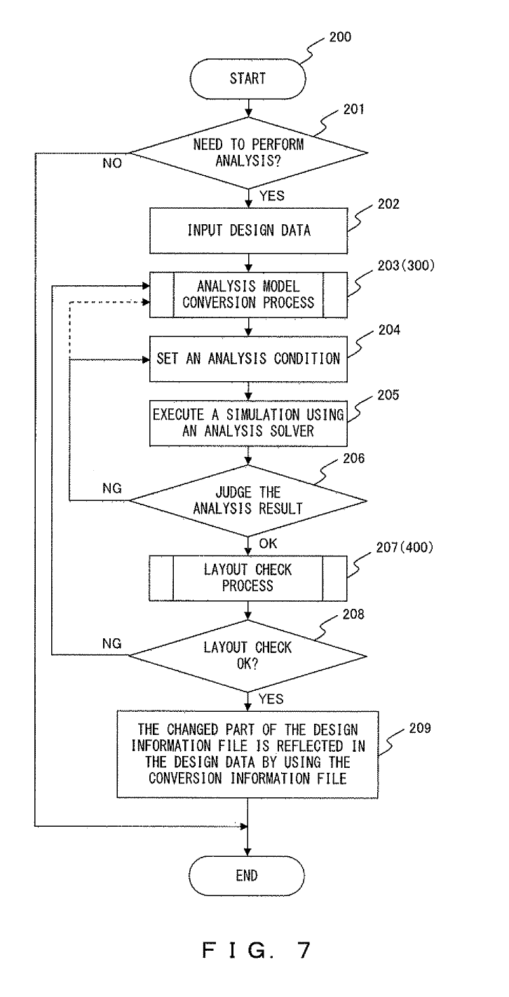

The following is a description of an example of the operation of the present embodiment by referring to the flow charts shown in FIGS. 7, 8 and 9.

The analysis process 200 exemplified in a flow chart of FIG. 7 discerns the presence or absence of the need to perform an analysis (step 201) and, if an analysis is judged to be required, the design data 30 is read (step 202).

The design data 30 stores information such as the size, geometry (i.e., form), placement method, and material property of a component constituting a product as the target of analysis.

Then, the design/analysis linkage system 20, in accordance with the design/analysis linkage program 21, carries out a design data/analysis model conversion process 300 for generating a design information file 40 from the design data 30 (step 203).

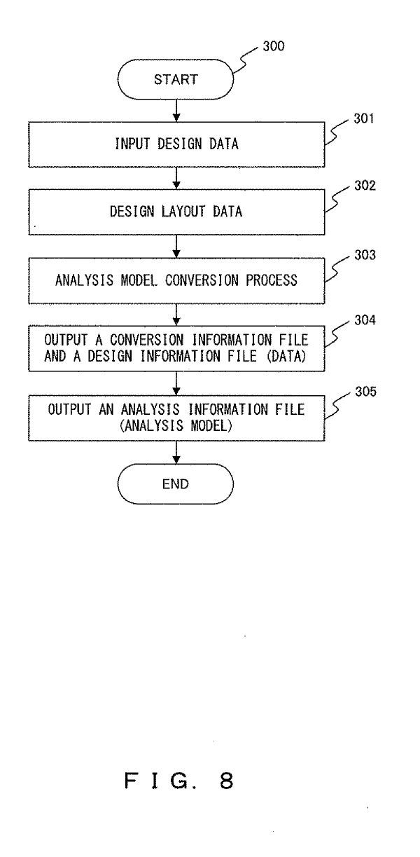

FIG. 8 is a flow chart exemplifying the design data/analysis model conversion process 300.

That is, the design/analysis linkage system 20, in accordance with the design/analysis linkage program 21 reads the design data 30 (step 301) and extracts layout data 40a (step 302).

It further reads component data 40b from the design data 30 and carries out the conversion process to an analysis model 60M (step 303).

The conversion process first applies a conversion process for omitting, for example, a screw hole of the individual component(s) of the design data 30 to output the result to the design information file 40 and also records the conversion process in the conversion information file 50.

It further generates an analysis information file 60 from the post-conversion design information file 40 for building up an analysis model 60M.

It then outputs the thusly obtained pieces of information to the design information file 40 and conversion information file 50 (step 304) and to the analysis information file 60 (step 305).

Returning to the flowchart of FIG. 7, the design/analysis linkage system 20, in accordance with the design/analysis linkage program 21, lets the user set the analysis condition of a physical simulation and the like as appropriate (step 204) and then transmits the analysis model 60M constituted by the analysis information file 60 to the analysis solver 18 and has the present analysis solver 18 carry out a physical simulation on the basis of the analysis model 60M (step 205).

It then receives the simulation result from the analysis solver 18 and discerns whether or not the present simulation result satisfies the analysis condition designated by the user (step 206).

If the simulation result does not satisfy the analysis condition designated by the user, the process returns to step 203 to let the user change the analysis information file 60 as appropriate, or the process returns to step 204 to receive a setup or change of a new analysis condition from the user.

In this event, if it is detected that the user has changed the analysis information file 60 in step 203, the design/analysis linkage system 20, in accordance with the design/analysis linkage program 21, updates both the linkage information part 67 of the analysis information file 60 and the corresponding linkage information part 45 of the design information file 40, thereby making it possible to inspect, from the design information file 40, the presence or absence of a change and/or addition to the analysis information file 60.

As such, after the physical simulation using the analysis model 60M satisfies a prescribed analysis condition, a layout check process 400 is executed (step 207).

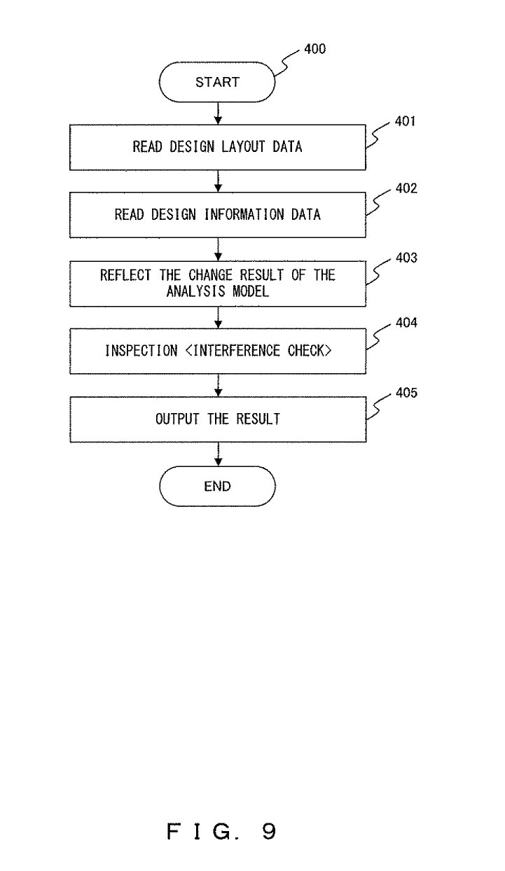

FIG. 9 is a flow chart exemplifying the layout check process 400.

First, design layout data is read from the design data 30 (step 401), and the design information file 40 is read (step 402).

Note that the design layout data read in step 401 is the data required for an interference check (which is described later) and the like among layout data other than the layout data 40a included in the design information file 40.

Then, the change result of the analysis model 60M is reflected in the design information file 40 by using the linkage information part 45 (step 403).

Then, the design information file 40 is input into the virtual product simulator 22 and the virtual product simulator 22 carries out checks such as checks for the presence or absence of interference between individual components and of the interference of a tool in the assembly track (step 404).

Then, the results of these checks are output to, for example, display apparatus 13 and/or a file (step 405).

Returning to the flow chart shown in FIG. 7, the changed content of the design information file 40 based on the above described physical simulation is reflected in the original design data 30 by an inverse conversion using the conversion information file 50 (step 209).

Note that a result of the reflection process for the design data 30 can be managed as a new generation (i.e., new version) by utilizing a generation management of, for example, the design data 30.

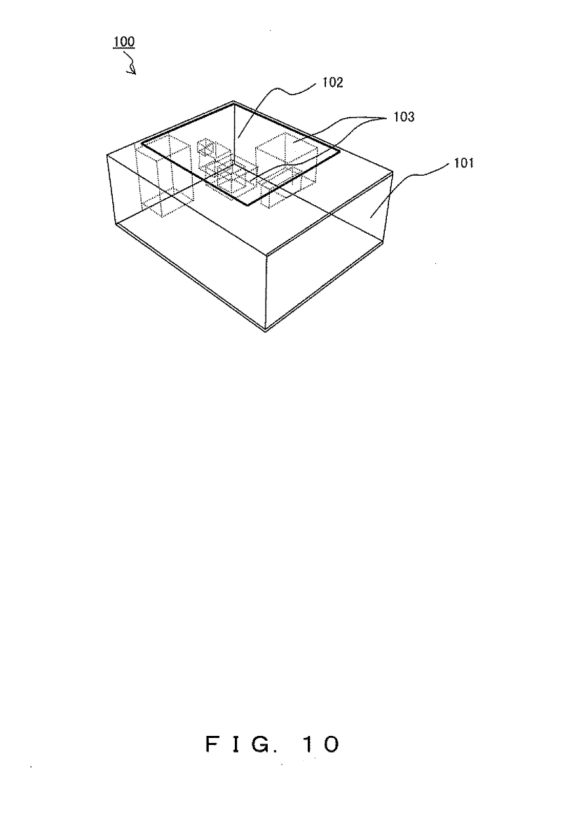

FIG. 10 is a conceptual diagram exemplifying the analysis model 60M of a product 100 to which a simulation method according to the present embodiment is applied.

The inside of the chassis 101 is equipped with a populated circuit board 102. A plurality of populated components 103 including, for example, microprocessor, memory, circuit elements and the like are mounted onto the populated circuit board 102.

The geometries (i.e., forms) of the chassis 101, populated circuit board 102, and populated components 103 and the like are simplified as, for example, a cube as a result of the change process using the simplification category 54 exemplified in FIG. 5 described above.

Then, the internal temperature distribution of the chassis 101 is analyzed by the physical simulation using the analysis model 60M, and the positions (i.e., the layout) and geometries of the populated components 103 within the analysis model 60M are adjusted so that the interior of the chassis 101 is no higher than the permissible temperature designated as the analysis condition.

In this event, the present embodiment is configured such that the changes in the geometries and positions of the chassis 101, populated circuit board 102, and the like that are applied to the analysis model 60M in the process of the analysis are reflected in the linkage information part 45 of the design information file 40 by way of the linkage information part 67 of the analysis information file 60. The reflection is made by the linkage process in accordance with the design/analysis linkage program 21.

This configuration makes it possible to feed the information obtained by the analysis process quickly back to the design and production processes.

For example, it has conventionally taken several hours to accomplish manually reflection of the information of the analysis information file 60 in the design information file 40; the method according to the present embodiment makes it possible to accomplish it in a few minutes.

The information of the analysis information file 60 obtained by an analysis process is automatically reflected in the design information file 40 of a design process, and thereby human mistakes such as mistakes in manually transcribing data are eliminated and the reliability of the data included in the design information file 40 and design data 30, to which the information of the analysis information file 60 is fed back, is improved.

Further, the presence or absence of interference in the populated circuit board 102 and the interference between individual populated components 103 are inspected by the virtual product simulator 22 in the analysis process, and therefore an interference check anew in the design stage is not necessary, and thereby the required time for the development process, during which the design and analysis are repeated, can be shortened.

As an example, a conventional manual task has taken about half a day for checking the presence or absence of interference in the populated circuit board 102 and populated components 103; the present embodiment makes it possible to shorten the required time for checking the presence or absence of interference to a few minutes.

As described above, the present embodiment is contrived to build up a mechanism to incorporate automatically into design data (such as CAD data) an alternative design idea in which the plan has been made clear through a simulation. Therefore, a plurality of items which are provided by the simulation and which require a design change are integrally managed and fed back to the design without mistakes.

That is, the present embodiment is characterized as, for example, firstly, reflecting both the positional information of an analysis model and the information of an analysis result in design information data in an environment in which the analysis model is created from the design information data.

It is also characterized as, for example, secondly, reflecting, in the design information data, the analysis information (e.g., geometry data, position data, component layout information, and the like) contained in an analysis model.

It is also characterized as, for example, thirdly, recording, in a database(s), pieces of information (e.g., information related to a component and/or a unit) that indicate both a pre-conversion state and a post-conversion state, respectively, when converting the design information data into an analysis model.

It is also characterized as, for example, fourthly, inspecting whether or not the layout information obtained by an analysis result is within an allowable range of the design.

The present embodiment is furnished with the function of linking data before and after a conversion, thereby making it possible to share data and accomplish the reflection of a design into an analysis and that of an analysis into a design smoothly.

The present embodiment makes it possible to feed back the most optimal component layout information of, for example, a circuit component, obtained by an analysis result correctly to the CAD data of, for example, a circuit design, and to reflect the feed back information in the circuit design quickly.

The present embodiment is further configured to reflect the layout information of a component(s) automatically in design data, thereby eliminating human errors and the like and improving the reliability of data.

It further makes it easy to check interferences in the optimal component layout obtained by an analysis result, thereby making it possible to shorten the time required for the development process in which the cycle of design, analysis and design is repeated.

The above-described embodiment is, with appropriate modifications, applicable to all environments in which an analysis model is generated from design data and physical phenomena are analyzed. As examples, it is applicable to techniques and such for analyzing thermal fluids, structures, electromagnetic waves, and the like in the fields of electronic devices, automobiles, building, et cetera.

Note that it must be clear that various other embodiments are possible with appropriate modifications, in lieu of being limited to the configuration exemplified in the above described embodiment.

What is claimed is:

1. An information processing apparatus, comprising:
an analysis model conversion unit generating an analysis model data from design information data;
an analysis result obtainment unit obtaining an analysis result in accordance with a physical simulation on the analysis model data after the analysis model data is generated by the analysis model conversion unit;
an analysis result judgment unit changing the analysis model data to re-perform the physical simulation by using the analysis result obtainment unit if the analysis result does not satisfy an analysis condition;
a layout check unit reflecting a change result of the analysis model data in the design information data to check a layout indicated by the design information data if the analysis result turns out to satisfy the analysis condition by the analysis result judgment unit; and
a layout check result judgment unit changing the analysis model data to re-perform the physical simulation by using the analysis result obtainment unit if a result of checking the layout indicates that the layout is improper.

2. An information processing apparatus, comprising:
an analysis model conversion unit generating an analysis model data from design information data; and
a linkage unit storing, in the design information data and the analysis model data, information that enables cross-reference among information changed in the analysis model data, the design information data, and the analysis model data, associating the analysis model data with the design information data, and reflecting an analysis result obtained by using the analysis model data in the design information data.

3. The information processing apparatus according to claim 2, wherein
the analysis result includes positional information, geometry information, and layout information of a component defined by the design information data.

4. The information processing apparatus according to claim 2, further comprising
a storage unit storing a category of conversion processing used by the analysis model conversion unit when converting the design information data related to an individual component into the analysis model data.

5. The information processing apparatus according to claim 2, further comprising
an inspection unit inspecting whether or not layout information, within the analysis model data, of an individual component obtained by the analysis result is within an allowable range of design.

6. A simulation method, comprising:
generating an analysis model data from design information data;
obtaining an analysis result in accordance with a physical simulation on the analysis model data after the analysis model data is generated;
changing the analysis model data to re-perform the physical simulation if the analysis result does not satisfy an analysis condition;
reflecting a change result of the analysis model data in the design information data to check a layout indicated by the design information data if the analysis result turns out to satisfy the analysis condition; and
changing the analysis model data to re-perform the physical simulation if a result of checking the layout indicates that the layout is improper.

7. A simulation method for making a computer execute steps of:
generating an analysis model data from design information data;
storing, in the design information data and the analysis model data, information that enables cross-reference among information changed in the analysis model data, the design information data, and the analysis model data;
associating the analysis model data with the design information data;
performing a simulation by using the analysis model data; and
reflecting an analysis result obtained from the simulation using the analysis model data into the design information data.

8. The simulation method according to claim 7, wherein
the analysis result includes positional information, geometry information, and layout information of a component defined by the design information data.

9. A computer-readable storage medium recording a simulation program to cause a computer to execute steps of:
generating an analysis model data from design information data;
obtaining an analysis result in accordance with a physical simulation on the analysis model data after the analysis model data is generated;
changing the analysis model data to re-perform the physical simulation if the analysis result does not satisfy an analysis condition;
reflecting a change result of the analysis model data in the design information data to check a layout indicated by the design information data if the analysis result turns out to satisfy the analysis condition; and
changing the analysis model data to re-perform the physical simulation if a result of checking the layout indicates that the layout is improper.

10. A computer-readable storage medium recording an information processing program for making a computer execute steps of:
generating an analysis model data from design information data;
storing, in the design information data and the analysis model data, information that enables cross-reference among information changed in the analysis model data, the design information data, and the analysis model data;
associating the analysis model data with the design information data;
performing a simulation by using the analysis model data; and
reflecting an analysis result obtained from the simulation using the analysis model data into the design information data.
